(19) United States
(12) Patent Application Publication
(10) Pub. No.: US 2025/0131274 A1
(43) Pub. Date: Apr. 24, 2025

(54) APPARATUS AND METHOD FOR DETECTOR SELECTION WITH NEURAL NETWORK

(71) Applicant: Samsung Electronics Co., Ltd., Gyeonggi-do (KR)

(72) Inventors: Shailesh CHAUDHARI, San Diego, CA (US); Hyukjoon KWON, San Diego, CA (US)

(21) Appl. No.: 18/619,579

(22) Filed: Mar. 28, 2024

Related U.S. Application Data
(60) Provisional application No. 63/592,791, filed on Oct. 24, 2023.

(51) Int. Cl. G06N 3/0895

(52) U.S. Cl. CPC G06N 3/0895

(57) ABSTRACT

A system and a method are disclosed for selecting a detector using an NN for each RE in a communication system. A method includes receiving, by the electronic device, at an inference time, a signal from a transmitting device; extracting features from the received signal; inputting the extracted features to an NN, which is trained, at least in part, with a normalization function; and selecting, for each RE, a detector from a set of detectors based on non-normalized outputs of the NN.

### CROSS-REFERENCE TO RELATED APPLICATION

This application claims the priority benefit under 35 U.S.C. § 119(e) of U.S. Provisional Application No. 63/592,791, filed on Oct. 24, 2023, the disclosure of which is incorporated by reference in its entirety as if fully set forth herein.

### TECHNICAL FIELD

The disclosure generally relates to detector selection using a neural network (NN). More particularly, the subject matter disclosed herein relates to improvements to dynamically select a multiple input, multiple output (MIMO) detector using an NN for each resource element (RE) in a transport block (TB) of a communication system.

### SUMMARY

Next-generation cellular wireless technologies such as long term evolution (LTE)-Advanced Pro and 5^{th} generation (5G) new radio (NR) adopt advanced MIMO transmission techniques in a wide frequency band to achieve the multi-Gbps speed in cellular networks.

However, due to large bandwidth and high data rate requirements, power consumption becomes a bottleneck in baseband modems. By reducing the computational complexity of a baseband modem, the power consumption may be reduced.

An RE is a basic unit of resources in the time-frequency domain, and may be represented by an orthogonal frequency division multiplexing (OFDM) symbol index and a subcarrier index. A resource block (RB) (or a physical RB (PRB)) may be defined, e.g., by N_{symb} consecutive OFDM symbols in the time domain and N_{RB} consecutive subcarriers in the frequency domain. Accordingly, in one slot, one RB may include N_{symb}×N_{RB} REs.

A MIMO detector is used to generate log-likelihood ratios (LLRs) for bits mapped to multiple REs in a TB using an OFDM-based frame structure. The LLRs are further processed by a decoder to recover the bits in the TB. In order to minimize block error rate (BLER), highly accurate LLRs should be generated by the detector. The quality of an LLR depends on instantaneous channel quality in an RE as well as the complexity of the detector used. In a typical communication receiver, the same detector is used for all REs (i.e., static utilization), without taking into account channel conditions in the RE. In such static detector utilization, a high complexity detector is required to achieve low BLER.

Previously, to achieve BLER close to that of a maximum-likelihood (ML) detector while reducing computational complexity, a dimension reduced ML (DR-ML) detector has been provided, which reduces the number of constellation points visited during LLR computation. However, the DR-ML detector is still statically utilized, i.e., the same detector is used for all REs, which may be problematic.

In static detector utilization, there is a trade-off between BLER and detector complexity. More specifically, if the complexity of a detector is reduced, then the BLER increases and vice versa.

To overcome this trade-off, dynamic selection of a detector has been proposed for each RE based on instantaneous channel condition in the RE, e.g., as described in U.S. Pat. No. 11,625,610. For example, a MIMO detector detection method for each RE may be provided by applying an NN, such as a multi-layer perceptron (MLP) network, to select a MIMO detector for each RE from a set of candidate detectors. The NN takes features derived from a channel as inputs. The NN is trained to map input features to an appropriate detector in a set of candidate detectors in order to minimize BLER. More specifically, the detector is selected from the set of candidate detectors using an output of a normalization layer (or module), e.g., a softmax layer (or module), at the output of the NN. That is, the NN output is fed to the softmax layer in order to select an appropriate detector.

However, a softmax module is difficult to implement in hardware. That is, implementing softmax has high hardware complexity.

To overcome these issues, systems and methods are described herein for performing NN based detector selection at inference time, based on outputs of a last layer of the NN, without applying softmax.

Additionally, systems and methods are described herein for performing conservative detector selection at inference time.

The above approaches improve on previous methods by reducing the hardware complexity of the detector selection.

In an embodiment, a method performed by an electronic device for detector selection is provided. The method includes receiving, by the electronic device, at an inference time, a signal from a transmitting device; extracting features from the received signal; inputting the extracted features to an NN, which is trained, at least in part, with a normalization function; and selecting, for each RE, a detector from a set of detectors based on non-normalized outputs of the NN.

In an embodiment, an electronic device is provided, which includes a transceiver; and a processor configured to receive, via the transceiver, at an inference time, a signal from a transmitting device, extract features from the received signal, input the extracted features to an NN, which is trained, at least in part, with a normalization function, and select, for each RE, a detector from a set of detectors based on non-normalized outputs of the NN.

In an embodiment, a non-transitory computer readable medium is provided that stores instructions, which when executed by an electronic device, control the electronic device to perform a method for detector selection including receiving, by the electronic device, at an inference time, a signal from a transmitting device; extracting features from the received signal; inputting the extracted features to an NN, which is trained, at least in part, with a normalization function; and selecting, for each RE, a detector from a set of detectors based on non-normalized outputs of the NN.

### BRIEF DESCRIPTION OF THE DRAWING

In the following section, the aspects of the subject matter disclosed herein will be described with reference to exemplary embodiments illustrated in the figures, in which:

FIG. 1 illustrates a diagram of a system for MIMO detector selection, according to an embodiment;

FIG. 2 illustrates NN operations during offline training, according to an embodiment;

FIG. 3 illustrates NN operations at inference time, according to an embodiment;

FIG. 4 is a flowchart illustrating a method of detector selection, at inference time, using an NN, according to an embodiment;

FIG. 5 is a block diagram of an electronic device in a network environment, according to an embodiment; and

FIG. 6 shows a system including a UE and a gNB in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As described above, previous methods for MIMO detector detection for each RE apply an NN, such as an MLP network, wherein the detector selection is based on an output of a normalization layer, such as a softmax layer. However, implementing a normalization function, such as softmax has high hardware complexity. Accordingly, a need exists for detector selection with reduced hardware complexity.

In accordance with an aspect of the disclosure, NN based detector selection can be performed based on a non-normalized output of a last layer of the NN, i.e., without applying a normalization function (e.g., a softmax function), which reduces complexity of NN based detector selection by removing the softmax function at inference time. The softmax function may still be used during offline training to train a classification network.

Additionally, although various embodiments are described below with reference to softmax as a normalization function, the present disclosure is not limited thereto. For example, other normalization function may be utilized in an NN during training, such as a sigmoid fun function, equiangular basis vectors (EBV), etc.

Additionally, various embodiments may include utilization of an NN that is not trained with a normalization function. For example, an NN may be utilized which has had no normalization training, and thus inherently foregoes utilization of a normalization function, such as a softmax function, at inference time. In various embodiments, an NN is only partially trained on, or only partially utilizes, a normalization function. For example, an NN may only utilize a normalization function such as a softmax function as a final step in data processing, but may not utilize a normalization function at all prior steps in data processing.

In accordance with another aspect of the disclosure, conservative detector selection may be at inference time. More specifically, assuming network outputs are arranged in an ascending order of detector complexity, conservative selection includes selecting a higher complexity detector than predicted based on a maximum value at the output layer.

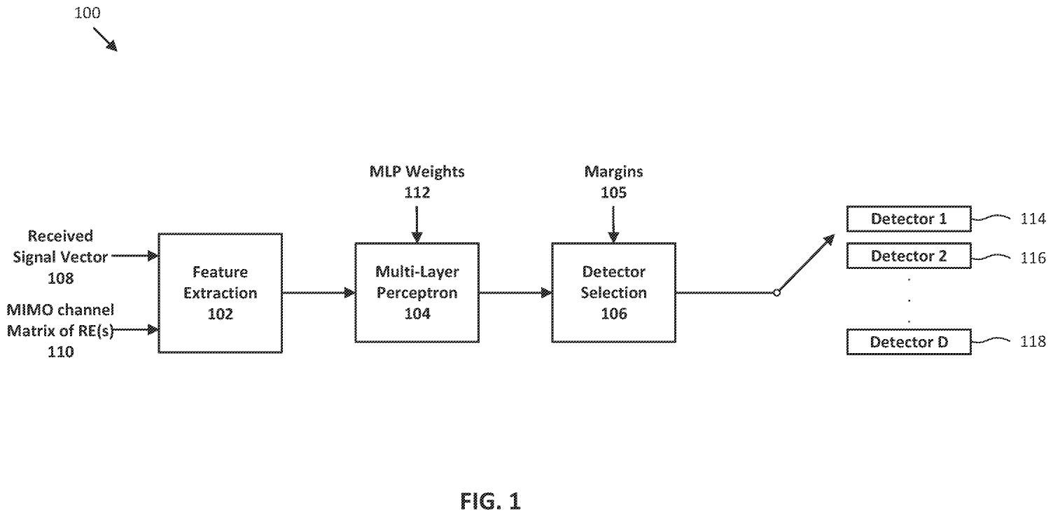

FIG. 1 illustrates a diagram of a system for MIMO detector selection, according to an embodiment.

Referring to FIG. 1, the system 100 includes a feature extraction module 102, an NN (e.g., an MLP network) 104, a detector selection module 106, and a plurality of detectors (e.g., detector 1 114, detector 2 116 . . . detector D 118). A received signal vector 108 and the MIMO channel matrix of RE(s) 110 are sent to the feature extraction module 102. MLP weights 112 are applied in the MLP network 104.

The features are provided as input to the MLP network 104. The features selected may represent the channel, received signal, noise variance, and other features. Other features may include eigenvalues of the channel, diagonal values of the channel matrix, and an inner product of received signals and channel.

The system 100 applies the MLP network 104 as a classifier to classify each RE into different classes based on its channel features, where each class corresponds to a detector. For each RE, the MLP network 104 provides D outputs, where D is the number of detector classes or candidate detectors. The dth output of the MLP network 104 indicates whether or not the detector d is the lowest-complexity detector that can provide performance similar to the ML detector. Inaccurate prediction by the MLP network 104 can increase the error rate. Therefore, the outputs of the MLP network 104 may be further processed in the detector selection module 106 that selects a highly reliable, low-complexity detector that matches an error rate of the ML. The parameters of the MLP network 104 (i.e., MLP weights 112) and the parameters (i.e., the margins 105) of the detector selection module 106 are tuned offline using the labelled dataset having channel features and corresponding labels of detector. The labelled dataset is collected under different channel models and signal-to-noise ratios (SNRs).

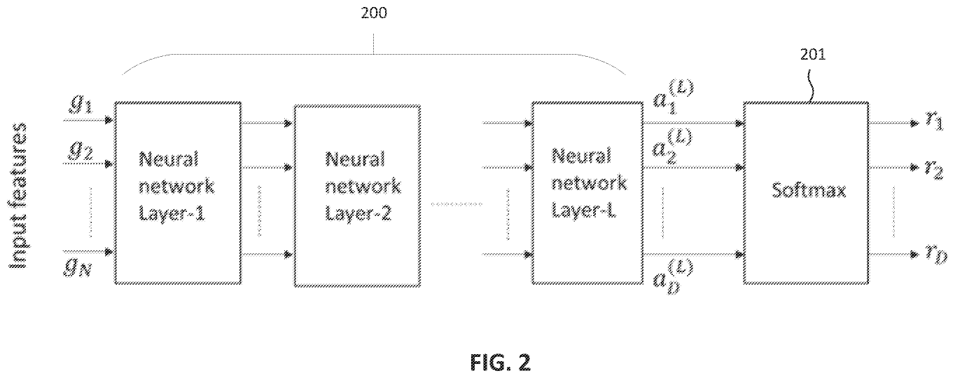

FIG. 2 illustrates NN operations during offline training, according to an embodiment. For example, the operations illustrated in FIG. 2 may be performed by the MLP network 104 illustrated in FIG. 1.

Referring to FIG. 2, an NN 200 is applied to select a MIMO detector for each RE from a set of candidate detectors. The input features to the NN 100 may be denoted by g₁, . . . gN The output of layer L of the NN 200 may be denoted by a₁^{(L)}, . . . a_{D}^{(L)}, where D is the number of candidate detectors.

In a classification problem, D indicates the number of classes, and the set of candidate detectors or classes may be denoted by Z_{D}={1, 2, . . . D}.

As shown in FIG. 2, in offline training, the output of the NN 200 is fed to a softmax layer 201 to obtain r₁, . . . r_{D}, which indicate the probability that the sample belongs to class d, where d E Z_{D}. Herein, the NN 200 may be trained with methods as described in U.S. Pat. No. 11,625,610, the entirety of which is incorporated by reference herein.

### Detector Selection at Inference Time

As described above, a softmax function at an output of an NN, e.g.,

$$Softmax ( {r}_{1} , {r}_{2} , … {r}_{D} ) = \{ \frac{{e}^{{r}_{1}}}{{\sum }_{d} {e}^{{r}_{d}}} , \frac{{e}^{{r}_{2}}}{{\sum }_{d} {e}^{{r}_{d}}} , … , \frac{{e}^{{r}_{D}}}{{\sum }_{d} {e}^{{r}_{d}}} \} ,$$

has high computational complexity due to exponential terms. To reduce the complexity, in accordance with an embodiment of the disclosure, a detector is directly selected based on outputs of the NN, e.g., a₁^{(L)}, a₂^{(L)}, . . . , a_{D}^{(L)}, without using a softmax.

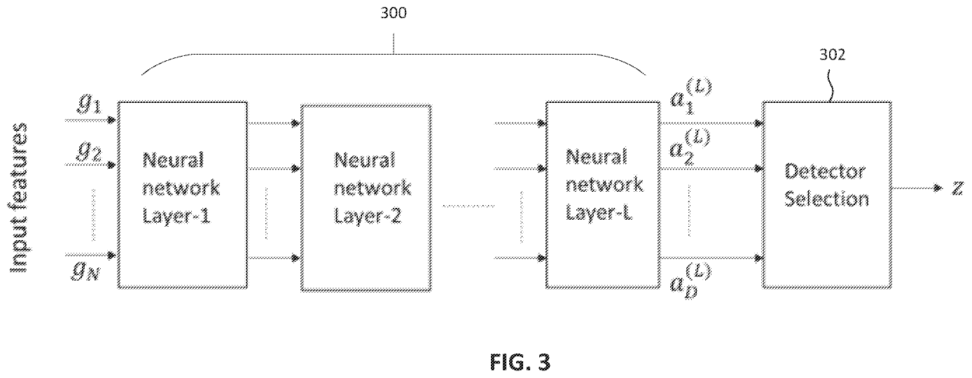

FIG. 3 illustrates an NN operations at inference time, according to an embodiment. For example, the operations illustrated in FIG. 3 may be performed by the MLP network 104 and the detector selection module 106 illustrated in FIG. 1.

Referring to FIG. 3, at inference time, i.e., when receiving signals in a communication system, an NN 300 is applied to select a MIMO detector for each RE from a set of candidate detectors. The input features to the NN 300 may be denoted by g₁, . . . g_{N}. The output of layer L of the NN 300 may be denoted by a₁^{(L)}, . . . a_{D}^{(L)}, where D is the number of candidate detectors or classes, and the set of candidate detectors or classes, in an ascending order, may be denoted by Z_{D}={1, 2, . . . D}.

As shown in FIG. 3, at inference time, the output of the NN 300 is fed to a detector selection layer (or module) 302 to select detector z, without the use of a softmax layer.

In accordance with an embodiment, the detector selection layer 302 may select the detector based on a maximum value, as shown in Equation (1) below.

$$z = arg {max}_{1 , 2 , … D} {a}_{d}^{( L )} \qquad ( 1 )$$

However, if the NN 300 was not perfectly trained, then selecting based on the maximum value alone may lead to higher decoding errors.

To address this issue, in accordance with an embodiment of the disclosure, a conservative selection may be performed.

### Conservative Selection

Here, it is assumed that a higher value of d in a candidate detector set Z_{D} indicates a higher complexity detector.

For conservative selection, a detector z is selected only if a corresponding output a_{z}^{(L)} exceeds all outputs corresponding to higher complexity detectors by some margin. For example, detector z may be selected in accordance with Equation (2).

$${a}_{z}^{( L )} \geq {a}_{d}^{( L )} + {γ}_{z , d} , d > z \qquad ( 2 )$$

In Equation (2), γ_{z,d}>0 is the margin to select detector z over detector d.

Table 1 below shows an example of a detector selection algorithm according to an embodiment of the disclosure, which may be utilized by the detector selection layer 302.

TABLE 1

| 1. | Initialize detector as z = 1 (lowest complexity detector) | |
|---|---|---|
| 2. | FOR d = 2 to D | |
| | a. | If a_{d}^{(L)} + γ_{z,d} > a_{z}^{(L)}, then |

| | |
|---|---|
| i. | z ← d (select higher complexity detector) |

| | |
|---|---|
| b. | ENDIF |

| | |
|---|---|
| 3. | ENDFOR |

The margins can be selected to keep the loss (e.g., a BLER gap) between NN based detector selection and a most complex candidate detector within a tolerable threshold.

For example, the same margins can be applied for all detectors, e.g., γ_{z,d}=γ. For γ_{z,d}=γ, i.e., the same margins for all detectors, the margins may be set during offline training using the algorithm shown in Table 2 below.

TABLE 2

| 1. | Initialize γ = 0 | |
|---|---|---|
| 2. | Obtain BLER (BLER_{γ}) by selecting detector by neural network and | |
| | margin = γ | |
| 3. | Obtain BLER (BLER*) by using most complex detector for all REs. | |
| 4. | If BLER_{γ} − BLER* > th, (th = tolerable BLER loss) | |
| | i. | then increment γ. |
| | ii. | Continue to step 2. |

Else

continue using γ as margin.

Additionally, larger values of margins will result in the selection of higher complexity detectors, making it a more conservative selection, while the margin=0 is the same as detector selection based on a maximum value as shown in Equation (1).

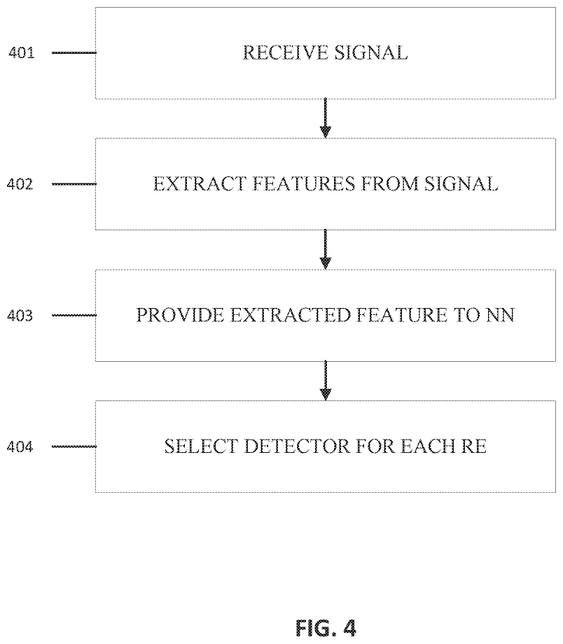

FIG. 4 is a flowchart illustrating a method of detector selection, at inference time, using an NN, according to an embodiment; Referring to FIG. 4, in step 401, a receiving device, e.g., a user equipment (UE), receives a signal from a transmitting device, e.g., a base station.

In step 402, the receiving device extracts features from the received signal. The extracted features may represent a channel, the received signal, noise variance, and other features such as eigenvalues of the channel, diagonal values of the channel matrix, and an inner product of received signals and channel.

In step 403, the receiving device feeds the extracted features, e.g., g₁, . . . g_{N}, as described above with reference to FIG. 3, to an NN, such as an MLP network. As described above with reference to FIG. 2, the NN is trained offline with a softmax layer to obtain r₁, . . . r_{D}, which indicate the probability that a sample belongs to class d, where d∈Z_{D}.

In step 404, the receiving device feeds the output of the NN to a detector selection module to select a detector for each RE, without the use of a softmax layer. As described above, with reference to FIG. 3, the output of layer L of the NN may be denoted by a₁^{(L)}, . . . a_{D}^{(L)}, where D is the number of candidate detectors or classes, and the set of candidate detectors or classes, in an ascending order, may be denoted by Z_{D}{1, 2, . . . D}.

In accordance with an embodiment, the detector selection module may select the detector based on a maximum value, e.g., as shown in Equation (1), or a detector selection algorithm, i.e., using conservative selection, as shown in Table 1.

The selected detector is then used to generate LLRs for bits mapped to multiple REs in a TB using the OFDM-based frame structure. The LLRs are further processed by a decoder to recover the bits in the TB.

Although FIG. 4 described above with reference to a UE being a receiving device and a base station being a transmitting device as example, the disclosure is not limited thereto. For example, the method of FIG. 4 may also be performed by a base station being a receiving device and a UE being a transmitting device.

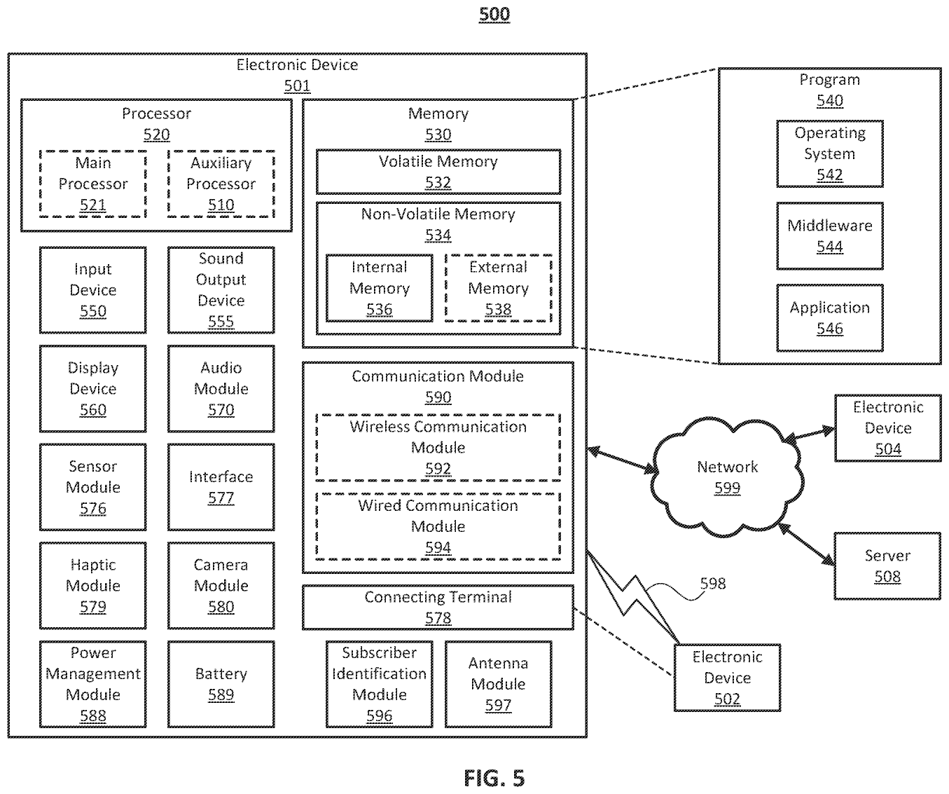

FIG. 5 is a block diagram of an electronic device in a network environment 500, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). For example, the electronic device 501 may be a receiving device that performs the method described above with reference to FIG. 4.

The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, e.g., a MIMO antenna array, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

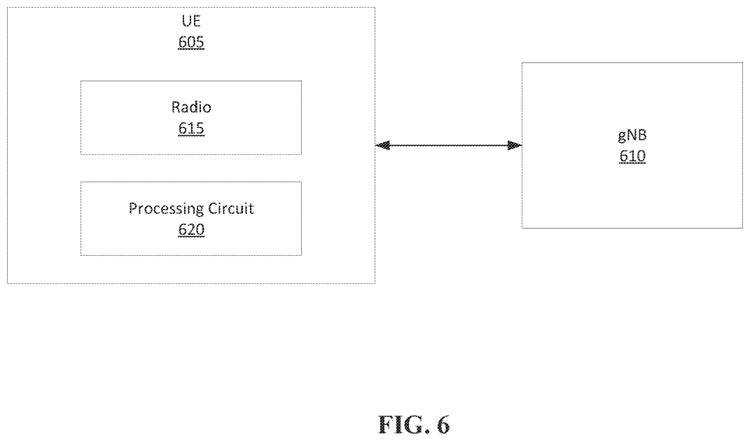

FIG. 6 shows a system including a UE 605 and a gNB 610, in communication with each other. The UE may include a radio 615 and a processing circuit (or a means for processing) 620, which may perform various methods disclosed herein, e.g., the method illustrated in FIG. 4. For example, the processing circuit 620 may receive, via the radio 615, transmissions from the network node (gNB) 610, and the processing circuit 620 may transmit, via the radio 615, signals to the gNB 610.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by an electronic device for detector selection, the method comprising:
receiving, by the electronic device, at an inference time, a signal from a transmitting device;
extracting features from the received signal;
inputting the extracted features to a neural network (NN), which is trained, at least in part, with a normalization function; and
selecting, for each resource element (RE), a detector from a set of detectors based on non-normalized outputs of the NN.

2. The method of claim 1, wherein the normalization function includes a softmax function.

3. The method of claim 1, wherein the NN includes an a multi-layer perceptron (MLP) network.

4. The method of claim 1, wherein the outputs of the NN are arranged in an ascending order of detector complexity.

5. The method of claim 4, wherein selecting the detector from the set of detectors based on the outputs of the NN comprises selecting a higher complexity detector than predicted based on a maximum value of the outputs.

6. The method of claim 5, wherein selecting the higher complexity detector than predicted based on the maximum value of the outputs comprises:
comparing a value of a predicted detector with a combined value of the higher complexity detector and a predetermined margin; and
selecting the higher complexity detector based on the comparison.

7. The method of claim 6, wherein the predetermined margin is calculated during training based on a comparison of block error rate (BLER) differences to a tolerable BLER loss.

8. An electronic device, comprising:
a transceiver; and
a processor configured to:
receive, via the transceiver, at an inference time, a signal from a transmitting device,
extract features from the received signal,
input the extracted features to a neural network (NN), which is trained, at least in part, with a normalization function, and
select, for each resource element (RE), a detector from a set of detectors based on non-normalized outputs of the NN.

9. The electronic device of claim 8, wherein the normalization function includes a softmax function.

10. The electronic device of claim 8, wherein the NN includes an a multi-layer perceptron (MLP) network.

11. The electronic device of claim 8, wherein the outputs of the NN are arranged in an ascending order of detector complexity.

12. The electronic device of claim 11, wherein the processor is further configured to select the detector from the set of detectors based on the outputs of the NN by selecting a higher complexity detector than predicted based on a maximum value of the outputs.

13. The electronic device of claim 12, wherein the processor is further configured to select the higher complexity detector than predicted based on the maximum value of the outputs by:
comparing a value of a predicted detector with a combined value of the higher complexity detector and a predetermined margin; and
selecting the higher complexity detector based on the comparison.

14. The electronic device of claim 6, wherein the predetermined margin is calculated during training based on a comparison of block error rate (BLER) differences to a tolerable BLER loss.

15. A non-transitory computer readable medium that stores instructions, which when executed by an electronic device, control the electronic device to perform a method for detector selection comprising:
receiving, by the electronic device, at an inference time, a signal from a transmitting device;
extracting features from the received signal;
inputting the extracted features to a neural network (NN), which is trained, at least in part, with a normalization function; and
selecting, for each resource element (RE), a detector from a set of detectors based on non-normalized outputs of the NN.

16. The non-transitory computer readable medium of claim 15, wherein the normalization function includes a softmax function, and
wherein the NN includes an a multi-layer perceptron (MLP) network.

17. The non-transitory computer readable medium of claim 15, wherein the outputs of the NN are arranged in an ascending order of detector complexity.

18. The non-transitory computer readable medium of claim 17, wherein selecting the detector from the set of detectors based on the outputs of the NN comprises selecting a higher complexity detector than predicted based on a maximum value of the outputs.

19. The non-transitory computer readable medium of claim 18, wherein selecting the higher complexity detector than predicted based on the maximum value of the outputs comprises:
comparing a value of a predicted detector with a combined value of the higher complexity detector and a predetermined margin; and
selecting the higher complexity detector based on the comparison.

20. The non-transitory computer readable medium of claim 19, wherein the predetermined margin is calculated during training based on a comparison of block error rate (BLER) differences to a tolerable BLER loss.
